(19) United States
(12) Patent Application Publication
(10) Pub. No.: US 2025/0008295 A1
(43) Pub. Date: Jan. 2, 2025

(54) SYSTEM AND METHOD FOR MULTI-LEVEL RECOGNITION AND LOCATION TRACKING WITHIN A PLURALITY OF ZONES

(71) Applicant: Uknomi, Inc., Dallas, TX (US)

(72) Inventors: Andreas Liebengerg, Pretoria (ZA); Srinivas Guddati, Flower Mound, TX (US); Johan Van Der Westhuizen, Dallas, TX (US)

(73) Assignee: Uknomi, Inc., Dallas, TX (US)

(21) Appl. No.: 18/343,677

(22) Filed: Jun. 28, 2023

(51) Int. Cl. H04W 4/021; H04W 4/80

(52) U.S. Cl. CPC H04W 4/021; H04W 4/80

(57) ABSTRACT

A system and method for multi-level recognition and location tracking within a plurality of zones, including: receiving in a training mode a plurality of training mode signals that are within range of one or more of a plurality of BLE beacon devices located at different fixed positions within one or more of the plurality of zones as the mobile training device is moved into different locations within each of the plurality of zones, and determining a received signal strength indictor for each of the received plurality of training mode signals; transmitting in the training mode a zone identifier and the received signal strength indictor for each of the received plurality of training mode signals to a centralized server over a computer network; receiving in the training mode the zone identifier and the received signal strength indictor for each of the received plurality of training mode signals; determining in the training mode a training mode digital fingerprint for each of the plurality of zones based on a combination of the plurality of received signal strength indicators; storing in the training mode the zone identifier and the training mode digital fingerprint for each of the plurality of zones in a database; receiving in an operational mode a plurality of operational mode signals that are within range of one or more of the plurality of BLE beacon devices, and determining a received signal strength indictor for each of the received plurality of operational mode signals; transmitting in the operational mode a mobile device identifier and the received signal strength indictor for each of the received plurality of operational mode signals to the centralized server over a computer network; an eighth computer code for receiving in the operational mode the mobile device identifier and the received signal strength indictor for each of the received plurality of operational mode signals; and comparing the digital fingerprint received in the operational mode to the plurality of digital fingerprints stored in the database in order to determine a matching one of the plurality of zones. The zone identifier identifies one of the plurality of zones in which the mobile training device is located when the plurality of training mode signals were received.

### BACKGROUND OF THE INVENTION

### Field of the Invention

The present invention is generally related to automated customer recognition and tracking, and more particularly to a system and method for multi-level recognition and location tracking within a plurality of zones.

### Discussion of the Background

Retail locations are typically partitioned into different zones. For example, without limitation, a fast-food restaurant may include an entry zone, a curb side zone, an order zone, a payment zone, a pickup zone, a seating zone, and an exit zone. Each of these zones serve different operational purposes at the retail location. It is often useful to track the customers in these areas. However, at existing retail locations there does not exist technologies that efficiently and automatically recognize and track of the movement of customers as they move within the different zones of the retail location. The lack of such automated recognition limits the ability of the retail location to track the optimize the operation of the retail location based on the movement its customers, recognize customer trends, and enhance the customer experience at the retail location.

Thus, there currently exist deficiencies in for recognition and location tracking of customers within the zones of a retail location.

### SUMMARY OF THE INVENTION

Accordingly, one aspect of the present invention is to provide a computer program product embodied on a computer readable medium for multi-level recognition and location tracking within a plurality of zones. The computer program product includes: (i) receiving in a training mode, by a mobile training device, a plurality of training mode Bluetooth signals that are within range of one or more of a plurality of Bluetooth BLE beacon devices located at different fixed positions within one or more of the plurality of zones as the mobile training device is moved into different locations within each of the plurality of zones, and determining a received signal strength indictor for each of the received plurality of training mode Bluetooth signals; (ii) transmitting in the training mode, by the mobile training device, a zone identifier and the received signal strength indictor for each of the received plurality of training mode Bluetooth signals to a centralized server over a computer network; (iii) receiving in the training mode, by the centralized server, the zone identifier and the received signal strength indictor for each of the received plurality of training mode Bluetooth signals; (iv) determining in the training mode, by the centralized server, a training mode digital fingerprint for each of the plurality of zones based on a combination of the plurality of received signal strength indicators; (v) storing in the training mode, by the centralized server, the zone identifier and the training mode digital fingerprint for each of the plurality of zones in a database; (vi) receiving in an operational mode, by a mobile device, a plurality of operational mode Bluetooth signals that are within range of one or more of the plurality of Bluetooth BLE beacon devices, and determining a received signal strength indictor for each of the received plurality of operational mode Bluetooth signals; (vii) transmitting in the operational mode, by the mobile device, a mobile device identifier and the received signal strength indictor for each of the received plurality of operational mode Bluetooth signals to the centralized server over a computer network; (viii) an eighth computer code for receiving in the operational mode, by the centralized server, the mobile device identifier and the received signal strength indictor for each of the received plurality of operational mode Bluetooth signals; and (ix) comparing, by the centralized server, the digital fingerprint received in the operational mode to the plurality of digital fingerprints stored in the database in order to determine a matching one of the plurality of zones. The zone identifier identifies one of the plurality of zones in which the mobile training device is located when the plurality of training mode Bluetooth signals were received.

Another aspect of the present invention is to provide a computer program product embodied on a computer readable medium for multi-level recognition and location tracking within a plurality of zones. The computer program product includes: (i) receiving in a training mode, by one or more of a plurality of access point devices located at different fixed positions within one or more of the plurality of zones, a plurality of training mode Wi-Fi signals that are within range of a training mobile device as the mobile training device is moved into different locations within each of the plurality of zones, and determining a received signal strength indictor for each of the received plurality of training mode Wi-Fi signals; (ii) transmitting in the training mode, by the one or more of a plurality of access point devices, a zone identifier and the received signal strength indictor for each of the received plurality of training mode Wi-Fi signals to a centralized server over a computer network; (iii) receiving in the training mode, by the centralized server, the zone identifier and the received signal strength indictor for each of the received plurality of training mode Wi-Fi signals; (iv) determining in the training mode, by the centralized server, a training mode digital fingerprint for each of the plurality of zones based on a combination of the plurality of received signal strength indicators; (v) storing in the training mode, by the centralized server, the zone identifier and the training mode digital fingerprint for each of the plurality of zones in a database; (vi) receiving in an operational mode, by one or more of a plurality of access point devices, a plurality of operational mode Wi-Fi signals that are within range of the mobile device, wherein and determining a received signal strength indictor each of the received plurality of operational mode Wi-Fi signals; (vii) transmitting in the operational mode, by the one or more of the plurality of access point devices, a mobile device identifier and the received signal strength indictor for each of the received plurality of operational mode Wi-Fi signals to the centralized server over a computer network; (viii) receiving in the operational mode, by the centralized server, the mobile device identifier and the received signal strength indictor for each of the received plurality of operational mode Wi-Fi signals; and (ix) comparing, by the centralized server, the digital fingerprint received in the operational mode to the plurality of digital fingerprints stored in the database in order to determine a matching one of the plurality of zones. The zone identifier identifies one of the plurality of zones in which the mobile training device is located when the plurality of training mode Wi-Fi signals were received.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1E are block diagrams illustrating systems for multi-level recognition and location tracking within a plurality of zones in accordance with an embodiment of the present invention;

FIG. 2A is a flow chart illustrating a method for multi-level recognition and location tracking within a plurality of zones in accordance with an embodiment of the present invention;

FIG. 2B is a flow chart illustrating another method for multi-level recognition and location tracking within a plurality of zones in accordance with another embodiment of the present invention;

FIG. 2C is a flow chart illustrating yet another method for multi-level recognition and location tracking within a plurality of zones in accordance with yet another embodiment of the present invention; and

FIGS. 3A-3B illustrate exemplary user interfaces for multi-level recognition and location tracking within a plurality of zones in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

The present invention recognizes and locates a customer using a digital signal fingerprint. According to an embodiment, the system communicates or interacts with a customer's smart phone or similar device having Bluetooth and/or Wi-Fi enabled capabilities. The system automatically recognizes nearby wireless Bluetooth (“BLE”) beacons or Wi-Fi signals. These signals are converted into digital fingerprints which are compared against digital fingerprints previously stored in a database for the purpose of determining a zone in which a customer is located based on the location of the customer's mobile device. Such information is useful in other functionality including without limitation associating this information with a previously registered customer.

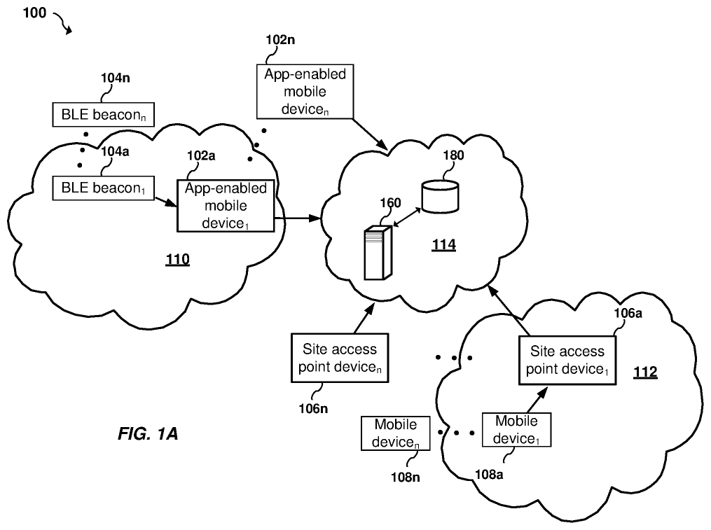

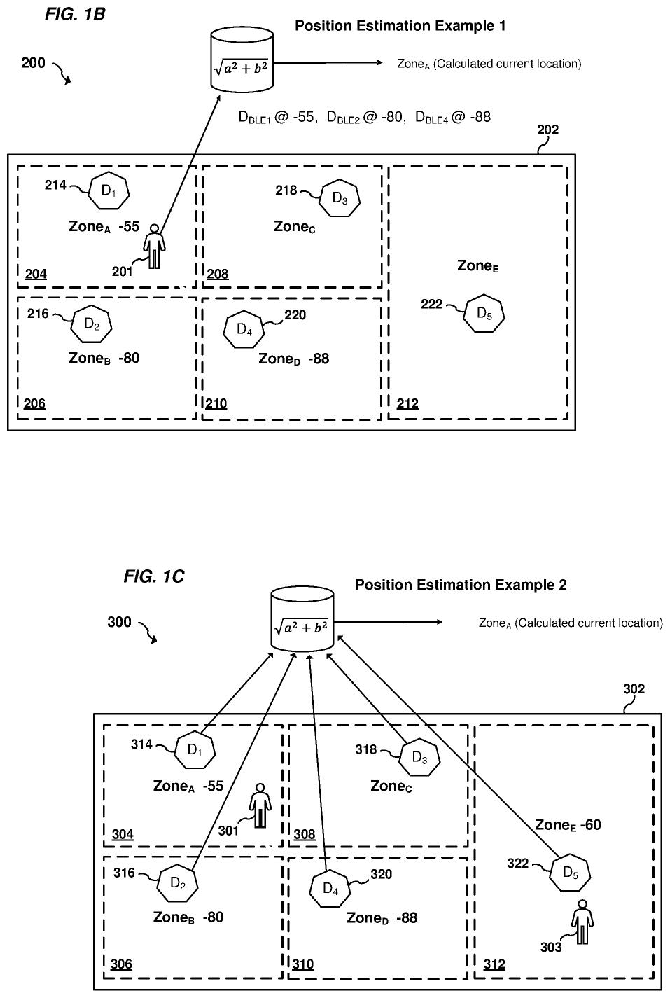

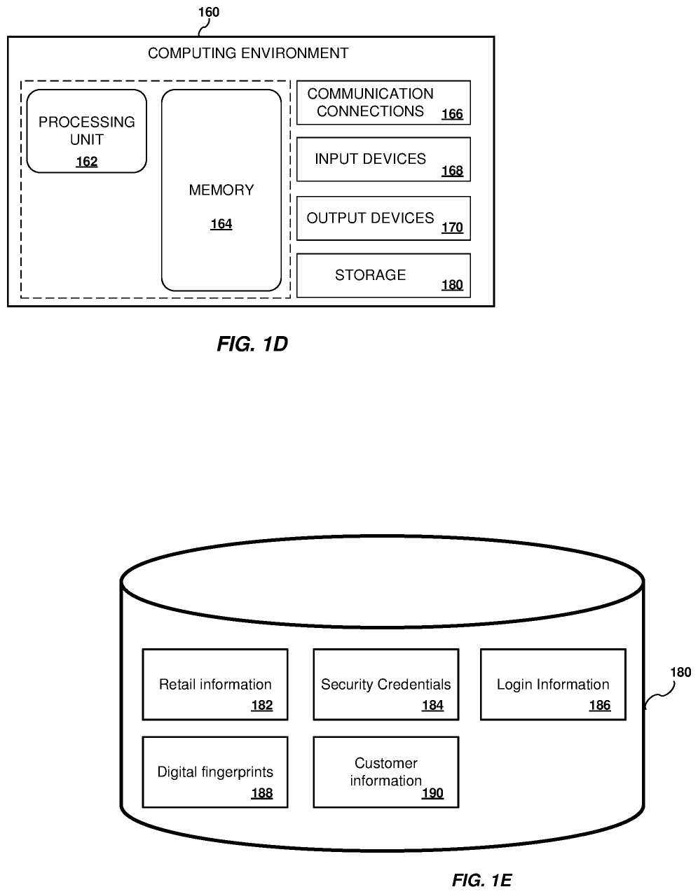

Referring to FIG. 1A, a block diagram illustrating an exemplary system for multi-level recognition and location tracking within a plurality of zones in accordance with an embodiment of the present invention, is shown. The system may include, without limitation, a centralized server 160 in communication with a database 180. As shown in FIG. 1E, database 180 may include without limitation retail information 182, security credentials 184, login information 186, digital fingerprints 188, and customer information 190.

As used herein, a “mobile device” is a device, such as without limitation a mobile phone, a PDA, laptop computer, tablet or the like, having Wi-Fi and/or Bluetooth capabilities. As used herein, an “app-enabled mobile device” is a device, such as without limitation a mobile phone, a PDA, laptop computer, tablet or the like, having Wi-Fi and/or Bluetooth capabilities and a uknomi app (also referred to as a software application) or an equivalent app installed and running on the device. It is understood, however, that the present invention is not limited to Wi-Fi and/or Bluetooth communication signals and instead other protocols and communication technologies could be utilized known today or not yet existing having similar capabilities within the scope of the present invention.

According to one embodiment, the system includes a plurality of Bluetooth BLE beacons 104a-n geographically distributed at a site location and configured to emit Bluetooth signals. App-enabled mobile devices 102a-n receive the Bluetooth signals from the one or more of these Bluetooth BLE beacons 104a-n within range 110 of the App-enabled mobile devices 102a-n. A received signal strength indicator is determined for each of received the Bluetooth signals by the particular app-enabled device and this information is communicated to the centralized server 160 via a communication network 114, such as without limitation Internet, Intranet or the like.

According to another embodiment, the system includes a plurality of access points 106a-n geographically distributed at a site location and configured to receive signals, including without limitation Wi-Fi and/or Bluetooth signals. Mobile devices 108a-n are typically configured today to automatically emit Wi-Fi and/or Bluetooth signals in search of Wi-Fi routers and/or Bluetooth-enabled devices within range 112 of the particular mobile device 108a-n. A received signal strength indicator is determined for each of received the Wi-Fi and/or Bluetooth signals by the access points 106a-n within range 112 of the mobile device 108a-n and this information is communicated from each of the within range access points 106a-n to the centralized server 160 via a communication network 114, such as without limitation Internet, Intranet or the like.

According to an embodiment, the system communicates or interacts with a software application residing on an app-enabled mobile device in communication with a Bluetooth BLE Beacon, or multiple Bluetooth BLE Beacons, at a fixed location such as without limitation a retail location, store, restaurant, business and/or the like. The app-enabled mobile device includes BLE capabilities that receives a BLE signal transmitted from one or more Bluetooth BLE Beacons. The Bluetooth signal is then used to determine app-enabled mobile device presence and location based on the received signal strength indicator for each of the Bluetooth signals received.

According to an embodiment, the system utilizes a unique pattern matching (“digital fingerprint”) algorithm. One or more Bluetooth BLE Beacons are installed at the location (site) and are configured to emit Bluetooth signals. Any app-enabled mobile device within range of the Bluetooth signals determines its received signal strength indicator and uploads this information is uploaded to a centralized server. A “configuration” algorithm (referred to as the “Site setup Application”) generates a unique pattern (a “digital fingerprint”) for a location based on a numerical combination of received signal strength indicators received by the app-enabled mobile device.

When a “location detection app” on an app-enabled mobile device is within Bluetooth range where one or more Bluetooth BLE beans are installed and active, it begins listening for previously identified devices at that location. With these digital signals, the algorithm communicates the digital signals received signal strength indicators continuously as the app-enabled mobile device moves through the site.

Digital fingerprints associated with the app-enabled mobile device representing its current location are compared against to the digital fingerprints previously stored in a database until a match is determined. Using a confidence factor the application identifies when the app-enabled mobile device is in the pre-determined (saved) locations and notifies the server that the app-enabled mobile device is in that location. This information is then used by other uKnomi functionality to provide personalized engagement with the customer (user of the app-enabled mobile device).

### BLE Algorithm & Configuration

One of the technologies that will be used for uKnomi to recognize and track customers, is BLE (Bluetooth Low Energy) beacon technology. The BLE beacon will measure the strength of the Bluetooth signal from a user's phone to calculate the distance the phone is from each of the beacons. This information is sent to the server where the correct position for the detected phone is triangulated and compared to the predefined zones of the restaurant.

This will determine in which zone (i.e., Entry, Curb side, Order, Payment, Pickup, Exit) and where in the inQ queue the customer should be added.

To perform this configuration and zone location calculation algorithm, a library was developed. A configuration app is installed on app-enabled mobile devices that use this library to calculate the app-enabled mobile device's current position within a site. The site is configured with zones and BLE beacons are placed throughout the site. The zones are then trained to obtain a fingerprint per zone. Next, the library is used to collect data from access points (AP) at the site and calculate the position of any mobile device in the site based on similar zone configuration and training.

### BLE Configuration App

Referring to FIG. 1B, a block diagram illustrating a non-limiting exemplary system for multi-level recognition and location tracking within a plurality of zones using Bluetooth BLE Beacons in accordance with an embodiment of the present invention is shown.

Various data structures are combined to calculate a location. As used herein, a “site” is without limitation a retail location, store, restaurant, quick service restaurant (QSR), business and/or the like. Each Site has a unique name. A site 200 is divided into a plurality of zones 204-212, where each zone has a unique name. A plurality of Bluetooth BLE Beacons 214-222 are strategically placed throughout the site 200. The site 200 is configured by training to determine a unique fingerprint for each zone 204-212.

As used herein, a “fingerprint” or “digital fingerprint” is a numerical representation of the BLE beacons that are visible to an app-enabled mobile device from within a zone; and the associated average RSSI signal strength related to each of the BLE beacons during the training period. As used herein, a “RSSI” or “Received Signal Strength Indicator”, is a measurement of either how well an app-enabled mobile device can hear a signal from a Bluetooth beacon or how well an access point or router can hear a Bluetooth and/or Wi-Fi signal from a mobile device. As is known in the art, an RSSI is typically used as a value that is useful for determining if a Wi-Fi enabled device has enough signal to get a good wireless connection. RSSI signals are negative and a small RSSI constitutes a strong signal, typically −10 to −50. A bigger RSSI constitutes a weak signal, typically −90 to −100.

The moment an app-enabled mobile device 201 that has an uKnomi App installed enters this site 200, the uKnomi App will send a signal to scan which BLE beacons 214-222 it can see and at which strength it can see each.

At any time, the app-enabled mobile device 201 will have a history for the last few seconds that shows a list of the detected BLE Beacons 214-222 and corresponding RSSI strength. This list of BLE beacon observations is mathematically compared to the fingerprint of each zone 204-212. The zone 204-212 with the best match is also the best candidate for the zone 204-212 in which the app-enabled mobile device 201 is currently located.

The actual calculation is a typical distance calculation. As shown in FIG. 1B, site 200 has five zones: Zone_{A} to Zone_{E} (204-212). The site has 5 BLE Beacons deployed: D₁ to D₅ (214-222). Each of the zones 204-212 has a fingerprint which consists of BLE beacons that can be seen from within the zone at certain RSSI strengths.

For example, Zone_{A} 204 has a fingerprint of:

D_{BLE1} @ RSSI-55

D_{BLE2} @ RSSI-80

D_{BLE4} @ RSSI-88

Based on this it is evident that Zone_{A} 204 cannot see BLE Beacons D₃ 218 or D₅ 222.

As an app-enabled mobile device 201 moves around the site and keeps track of BLE Beacons 214-222 that are observed, the app-enabled mobile device 201 can at any stage request the library to calculate its current zone 214.

Assuming that the current BLE Beacons 214-222 observed by app-enabled mobile device 201 in the last 10 seconds are:
D_{BLE1} @ RSSI-55
D_{BLE2} @ RSSI-80
D_{BLE5} @ RSSI-88

The calculation to compare the current position with the Zone_{A} fingerprint would then be:

$$\begin{matrix}distance = \sqrt{{( {Z}_{BLE 1} - {D}_{BLE 1} )}^{2} + {( {Z}_{BLE 2} - {D}_{BLE 2} )}^{2} + {( {Z}_{BLE 5} - {D}_{BLE 5} )}^{2}} \\ = \sqrt{{( - 50 + 55 )}^{2} + {( - 85 + 80 )}^{2} + {( - 90 + 88 )}^{2}} \\ = \sqrt{25 + 25 + 4} \\ = 7.35\end{matrix}$$

Such a small distance indicates a strong match and probability of this being the correct Zone. This distance calculation is performed against all zone fingerprints and the zone with the smallest distance is the Zone the device is most likely in.

There are some complications to consider. For instance, if an app-enabled mobile device 201 can see an additional BLE Beacon which is not part of a zone fingerprint and/or a zone fingerprint contains a BLE Beacon which is not observed by the device. In this case an inverse distance calculation is applied to those BLE Beacons with an assumed RSSI of 100. This is because if you can just faintly see a BLE Beacon the RSSI would be close to −100.

To illustrate this, the calculation is first done with RSSI of −95.

$$\begin{matrix}distance = \sqrt{{( {Z}_{BLE 1} - {D}_{BLE 1} )}^{2}} \\ = \sqrt{{( - 95 + 0 )}^{2}} \\ = 95\end{matrix}$$

It will have a disproportional high impact of not seeing a probably faint BLE Device.

Where the assumed RSSI of −100 is used the calculation would be:

$$\begin{matrix}distance = \sqrt{{( - 95 + 100 )}^{2}} \\ = \sqrt{{( 5 )}^{2}} \\ = 5\end{matrix}$$

This smaller penalty (5 vs 95) of not seeing a potentially faint device is appropriate.

The opposite also holds: For example, if a fingerprint contained a BLE Beacon with a strong RSSI of −10 and is then not observed by the device it would have a big impact of

$$\begin{matrix}distance = \sqrt{{( - 100 + 10 )}^{2}} \\ = \sqrt{{( 90 )}^{2}} \\ = 90\end{matrix}$$

Which is again an appropriate penalty for not seeing BLE Beacon that should have been observed with a strong RSSI.

### Use by Access Point

Referring to FIG. 1C, a block diagram illustrating a non-limiting exemplary system for multi-level recognition and location tracking within a plurality of zones using access points 314-322 in accordance with an embodiment of the present invention is shown. This embodiment uses similar logic as described with respect to the previous example to calculate position based on data received from a AP (Access Point) 314-322. This could typically be Bluetooth and/or Wi-Fi signals. The aim will be to track mobile devices 301 and 303 through a site 300 with no specific software installed or specific permission granted.

The following assumptions are made:
No software is needed on the mobile device
Bluetooth and/or Wi-Fi should be turned on for the device
There are APs at the Site that are configured to report on any device seen at the site to a central server (such as without limitation a Webserver).
This central server will use the BLE library to collect data from different Devices that were seen from different APs; and the corresponding times and RSSI values.
The BLE library can then be used to query a Device's Zone and raise events as devices move through the Site.
Training for the Site/Zone fingerprints are done similarly to the training of Zones with BLE Beacons.

The following paragraph provides a high-level overview of how this works.

Each AP 314-322 at the site 300 is configured to report observed mobile devices 301 and 303 to a central server by any known means, such as without limitation a Web Service. This central server will log each access point's observation of a mobile device within a zone of a site with the basic data of: SiteID, APID, DeviceID, RSSI. The library will keep track of observations for each mobile device similar to what has been described in the Bluetooth BLE Beacon example above.

The moment a mobile device 301 or 303 observation is received, the access points 314-322 will provide the information required to automatically calculate the estimated current zone 302-312 of the mobile device 301 or 303 based on comparing the history of AP observations received in the immediate past for the device to the fingerprints of the configured zones 314-322 for the site 300.

The following events will be raised by the library that any business logic can subscribe to:
DeviceEntered—This event is raised when a specific Device is seen for the first time at a Site
DeviceChangedZone—This event is raised with each Zone change observed for the Device
DeviceLeft—This event is raised when a Device has not been observed for a certain configurable time typically 30 seconds.
   Methods for Multi-Level Recognition and Location Tracking within a Plurality of Zones

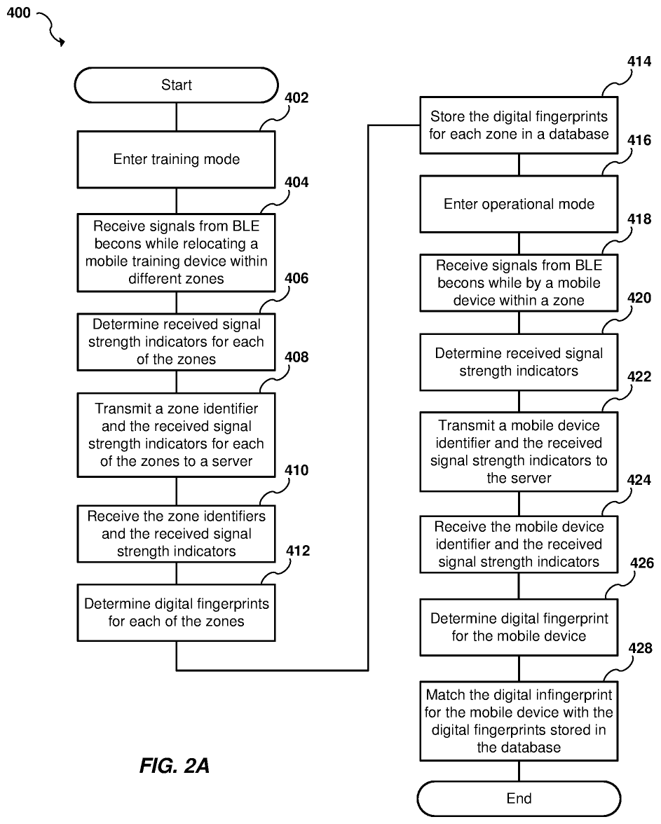

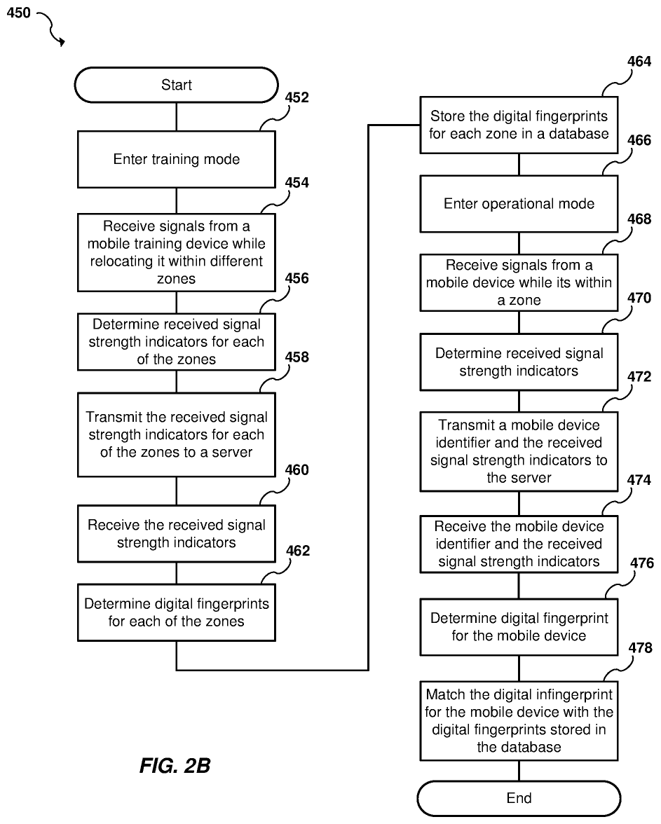

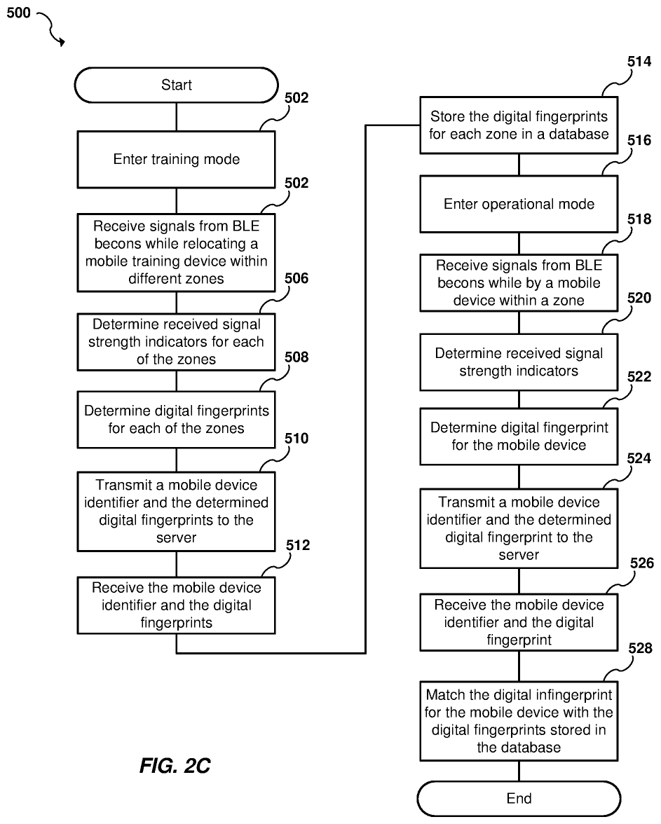

Referring to FIG. 2A, a flow chart illustrating a method for multi-level recognition and location tracking within a plurality of zones. At block 402, the system enters a training mode. A plurality of Bluetooth signals are received by a mobile training device from a plurality of Bluetooth BLE beacon devices located at different fixed positions within one or more of the plurality of zones as the mobile training device is moved into different locations within a zone, at block 404. At block 406, for each of the plurality of zones, a received signal strength indictor is determined for each of the received plurality of Bluetooth signals. Steps 404 and 406 are repeated for each of the plurality of zones. The mobile training device transmits a zone identifier and the received signal strength indictor for each of the received plurality of training mode Bluetooth signals to a centralized server over a computer network, at block 408. The zone identifier is used to identify the particular zone in which the mobile training device is located when the plurality of Bluetooth signals were received. At block 410, the zone identifier and the received signal strength indictor for each of the received plurality of training mode Bluetooth signals are received by the centralized server. A training mode digital fingerprint for each of the plurality of zones based on a combination of the plurality of received signal strength indicators is determined by the centralized server, at block 412. At block 414, the zone identifier and the training mode digital fingerprint for each of the plurality of zones are stored in a database. It is understood that steps 404-414 may be performed individually for each zone of the plurality of zones or collectively for the plurality of zones within the scope of the present invention.

The system then enters an operational mode, at block 416. At block 418, a plurality of operational mode Bluetooth signals that are within range of one or more of the plurality of Bluetooth BLE beacon devices are received by a mobile device. A received signal strength indictor is determined for each of the received plurality of operational mode Bluetooth signals, at block 420. At block 422, a mobile device identifier and the received signal strength indictor for each of the received plurality of operational mode Bluetooth signals to the centralized server over a computer network is transmitted by the mobile device to a centralized server. The mobile device identifier and the received signal strength indictor for each of the received plurality of operational mode Bluetooth signals is received by the centralized server, at block 424. At block 426, a digital fingerprint is determined which is without limitation a numerical value associated with a combination the received signal strength indictors. The digital fingerprint is then compared by the centralized server to the plurality of digital fingerprints stored in the database in order to determine a matching one of the plurality of zones, at block 428.

Referring to FIG. 2B, a flow chart illustrating another method for multi-level recognition and location tracking within a plurality of zones. At block 452, the system enters a training mode. Wi-Fi and/or Bluetooth signals are received by a plurality of access point devices located at different fixed positions within one or more of the plurality of zones from a mobile training device as it is moved into different locations within a zone, at block 454. At block 456, a received signal strength indictor is determined for each of the received plurality of Wi-Fi and/or Bluetooth signals. Steps 454 and 466 are repeated for each of the plurality of zones. Each of the access point devices within communication range of the mobile training device transmit the received signal strength indictor for each signals to a centralized server over a computer network, at block 458. At block 460, the received signal strength indictor for each of the received plurality of training mode Bluetooth signals are received by the centralized server. A training mode digital fingerprint for each of the plurality of zones based on a combination of the plurality of received signal strength indicators is determined by the centralized server, at block 462. At block 464, the training mode digital fingerprint for each of the plurality of zones are stored in a database. It is understood that steps 454-464 may be performed individually for each zone of the plurality of zones or collectively for the plurality of zones within the scope of the present invention.

The system then enters an operational mode, at block 466. At block 468, a plurality of operational mode Wi-Fi and/or Bluetooth signals that are within range of a mobile device are received by one or more of the plurality of access point devices. A received signal strength indictor is determined for each of the received plurality of operational mode Wi-Fi and/or Bluetooth signals, at block 470. At block 472, a mobile device identifier and the received signal strength indictor for each of the received plurality of operational mode Bluetooth signals to the centralized server over a computer network is transmitted by the one or more of the plurality of access point devices within range to a centralized server. The mobile device identifier and the received signal strength indictor for each of the received plurality of operational mode Bluetooth signals is received by the centralized server, at block 474. At block 476, a digital fingerprint is determined which is without limitation a numerical value associated with a combination the received signal strength indictors. The digital fingerprint is then compared by the centralized server to the plurality of digital fingerprints stored in the database in order to determine a matching one of the plurality of zones, at block 478.

Referring to FIG. 2C, a flow chart illustrating yet another method for multi-level recognition and location tracking within a plurality of zones. At block 502, the system enters a training mode. A plurality of Bluetooth signals are received by a mobile training device from a plurality of Bluetooth BLE beacon devices located at different fixed positions within one or more of the plurality of zones as the mobile training device is moved into different locations within a zone, at block 504. At block 506, a received signal strength indictor is determined for each of the received plurality of Bluetooth signals. Steps 504 and 506 are repeated for each of the plurality of zones. A training mode digital fingerprint for each of the plurality of zones based on a combination of the plurality of received signal strength indicators is determined by the mobile training device, at block 508. At block 510, the mobile training device transmits a zone identifier and the training mode digital fingerprint for each of the received plurality of training mode Bluetooth signals to a centralized server over a computer network. The zone identifier is used to identify the particular zone in which the mobile training device is located when the plurality of Bluetooth signals were received. The zone identifier and the training mode digital fingerprint for each of the received plurality of training mode Bluetooth signals are received by the centralized server, at block 512. At block 514, the zone identifier and the training mode digital fingerprint for each of the plurality of zones are stored in a database. It is understood that steps 504-514 may be performed individually for each zone of the plurality of zones or collectively for the plurality of zones within the scope of the present invention.

The system then enters an operational mode, at block 516. At block 518, a plurality of operational mode Bluetooth signals that are within range of one or more of the plurality of Bluetooth BLE beacon devices are received by a mobile device. A received signal strength indictor is determined for each of the received plurality of operational mode Bluetooth signals, at block 520. A digital fingerprint is determined which is without limitation a numerical value associated with a combination the received signal strength indictors, at block 522. At block 524, a mobile device identifier and the digital fingerprint for each of the received plurality of operational mode Bluetooth signals to the centralized server over a computer network is transmitted by the mobile device to a centralized server. The mobile device identifier and the digital fingerprint for each of the received plurality of operational mode Bluetooth signals is received by the centralized server, at block 526. The digital fingerprint is then compared by the centralized server to the plurality of digital fingerprints stored in the database in order to determine a matching one of the plurality of zones, at block 528.

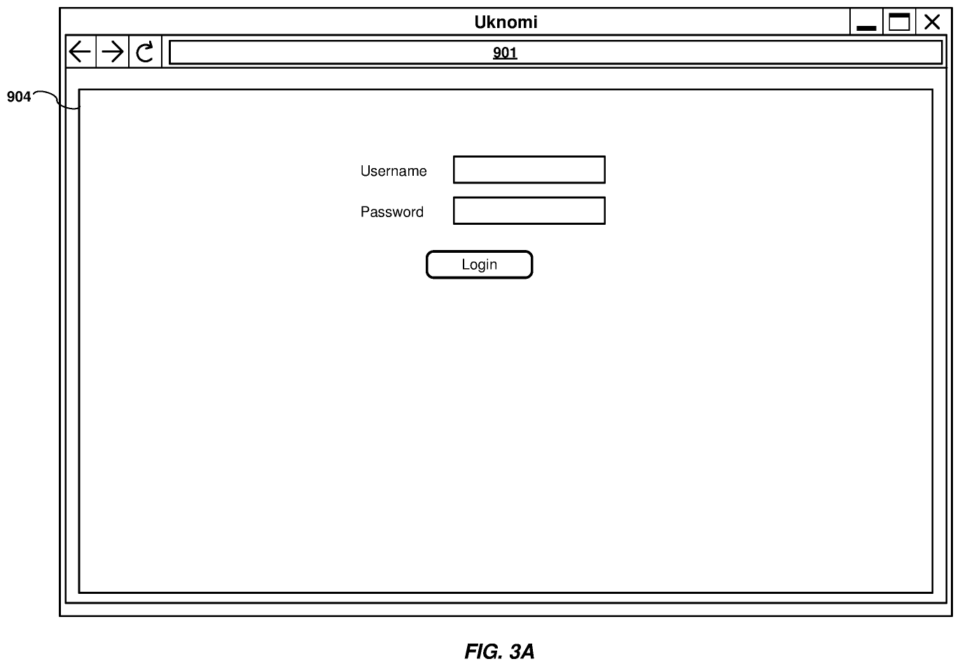

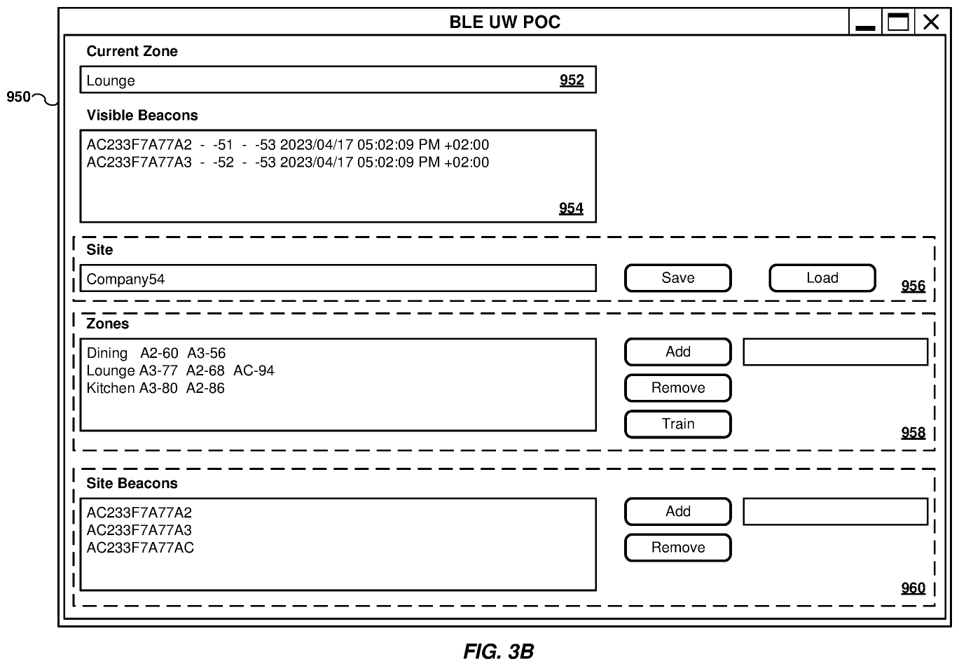

As shown in FIGS. 3A-3B, exemplary user interfaces for multi-level recognition and location tracking within a plurality of zones in accordance with an embodiment of the present invention is shown. FIG. 3A illustrates a non-limiting example of a login screen 904 to the uknomi server. However, it is understood that the system is not limited to utilizing a uknomi server and any server having similar capabilities is within the scope of the present invention. FIG. 3B illustrates a non-limiting example of BLE mobile device training user interface 950. The interface includes without limitation a current zone 952, visible beacons 954, a site area 956, a zones area 958, and a site beacons area 960. According to a non-limiting embodiment, the zones area 958 allows zones to be added, removed or trained. The site beacons area 960 allows site beacons to be added and removed and the site area 956 allows for sites to be saved or loaded.

As shown in FIG. 1D, present invention includes a computer program which may be hosted on a storage medium or other computer readable medium 180 and includes instructions which perform the processes set forth herein using memory 164 and a processing unit 162 contained within a computing environment 160. The storage medium or other computer readable medium 180 can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions. The computing environment 160 may include communication connections 166, input devices 168 and output devices 170.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a computer readable medium for multi-level recognition and location tracking within a plurality of zones, the computer program product comprising:
a first computer code for receiving in a training mode, by a mobile training device, a plurality of training mode Bluetooth signals that are within range of one or more of a plurality of Bluetooth BLE beacon devices located at different fixed positions within one or more of the plurality of zones as the mobile training device is moved into different locations within each of the plurality of zones, wherein a received signal strength indictor is determined for each of the received plurality of training mode Bluetooth signals;
a second computer code for transmitting in the training mode, by the mobile training device, a zone identifier and the received signal strength indictor for each of the received plurality of training mode Bluetooth signals to a centralized server over a computer network, wherein the zone identifier identifies one of the plurality of zones in which the mobile training device is located when the plurality of training mode Bluetooth signals were received;
a third computer code for receiving in the training mode, by the centralized server, the zone identifier and the received signal strength indictor for each of the received plurality of training mode Bluetooth signals;
a fourth computer code for determining in the training mode, by the centralized server, a training mode digital fingerprint for each of the plurality of zones based on a combination of the plurality of received signal strength indicators;
a fifth computer code for storing in the training mode, by the centralized server, the zone identifier and the training mode digital fingerprint for each of the plurality of zones in a database;
a sixth computer code for receiving in an operational mode, by a mobile device, a plurality of operational mode Bluetooth signals that are within range of one or more of the plurality of Bluetooth BLE beacon devices, wherein a received signal strength indictor is determined for each of the received plurality of operational mode Bluetooth signals;
a seventh computer code for transmitting in the operational mode, by the mobile device, a mobile device identifier and the received signal strength indictor for each of the received plurality of operational mode Bluetooth signals to the centralized server over a computer network;
an eighth computer code for receiving in the operational mode, by the centralized server, the mobile device identifier and the received signal strength indictor for each of the received plurality of operational mode Bluetooth signals;
a ninth computer code for comparing, by the centralized server, the digital fingerprint received in the operational mode to the plurality of digital fingerprints stored in the database in order to determine a matching one of the plurality of zones.

2. The computer program product of claim 1, wherein the combination of the plurality of received signal strength indicators is the square root of the square of the sum of the plurality of received signal strength indicators.

3. The computer program product of claim 2, wherein each of plurality of Bluetooth BLE beacon devices is located within the plurality of zones at a retail location.

4. The computer program product of claim 3, wherein each of the plurality of zones is selected from one of the group consisting of an entry zone, a curb side zone, an order zone, a payment zone, a pickup zone, and an exit zone.

5. A computer program product embodied on a computer readable medium for multi-level recognition and location tracking within a plurality of zones, the computer program product comprising:
a first computer code for receiving in a training mode, by one or more of a plurality of access point devices located at different fixed positions within one or more of the plurality of zones, a plurality of training mode Wi-Fi signals that are within range of a training mobile device as the mobile training device is moved into different locations within each of the plurality of zones, wherein a received signal strength indictor is determined for each of the received plurality of training mode Wi-Fi signals;
a second computer code for transmitting in the training mode, by the one or more of a plurality of access point devices, a zone identifier and the received signal strength indictor for each of the received plurality of training mode Wi-Fi signals to a centralized server over a computer network, wherein the zone identifier identifies one of the plurality of zones in which the mobile training device is located when the plurality of training mode Wi-Fi signals were received;
a third computer code for receiving in the training mode, by the centralized server, the zone identifier and the received signal strength indictor for each of the received plurality of training mode Wi-Fi signals;
a fourth computer code for determining in the training mode, by the centralized server, a training mode digital fingerprint for each of the plurality of zones based on a combination of the plurality of received signal strength indicators;
a fifth computer code for storing in the training mode, by the centralized server, the zone identifier and the training mode digital fingerprint for each of the plurality of zones in a database;
a sixth computer code for receiving in an operational mode, by one or more of a plurality of access point devices, a plurality of operational mode Wi-Fi signals that are within range of the mobile device, wherein a received signal strength indictor is determined for each of the received plurality of operational mode Wi-Fi signals;
a seventh computer code for transmitting in the operational mode, by the one or more of the plurality of access point devices, a mobile device identifier and the received signal strength indictor for each of the received plurality of operational mode Wi-Fi signals to the centralized server over a computer network;
an eighth computer code for receiving in the operational mode, by the centralized server, the mobile device identifier and the received signal strength indictor for each of the received plurality of operational mode Wi-Fi signals;
a ninth computer code for comparing, by the centralized server, the digital fingerprint received in the operational mode to the plurality of digital fingerprints stored in the database in order to determine a matching one of the plurality of zones.

6. The computer program product of claim 5, wherein the combination of the plurality of received signal strength indicators is the square root of the square of the sum of the plurality of received signal strength indicators.

7. The computer program product of claim 6, wherein each of plurality of Bluetooth BLE beacon devices is located within the plurality of zones at a retail location.

8. The computer program product of claim 7, wherein each of the plurality of zones is selected from one of the group consisting of an entry zone, a curb side zone, an order zone, a payment zone, a pickup zone, and an exit zone.
